(19) United States
(12) Patent Application Publication
(10) Pub. No.: US 2002/0007840 A1
(43) Pub. Date: Jan. 24, 2002

(54) Substrate cleaning apparatus, substrate cleaning method and substrate processing apparatus

(76) Inventor: Koji Atoh, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 09/907,716

(22) Filed: Jul. 19, 2001

(30) Foreign Application Priority Data
Jul. 21, 2000 (JP) 220824/2000

(51) Int. Cl. B08B 7/04

(52) U.S. Cl. 134/1.3; 15/77; 15/88.3; 134/6; 134/33

(57) ABSTRACT

A substrate cleaning apparatus, a substrate cleaning method and a substrate processing apparatus wherein contamination in a roller type cleaning member used for cleaning a pattern forming surface is slowed down and the time for replacing the cleaning member is delayed. The substrate is cleaned while supplying a cleaning liquid which is given ultrasonic energy and/or had the cavitation generated therein from the cleaning liquid nozzle onto a surface of the substrate to be cleaned.

### BACKGROUND OF THE INVENTION

The present invention relates to a substrate cleaning apparatus, a substrate cleaning method and a substrate processing apparatus used in processes for manufacturing devices such as semiconductor devices.

For this kind of substrate cleaning apparatus, there has been used one prior art substrate cleaning apparatus, which comprises a substrate turning mechanism for turning a substrate on an approximately horizontal plane, a pair of roller type cleaning members rotating around respective rotary shafts disposed approximately parallel to respective surfaces of said substrate turning on said substrate turning mechanism, and a cleaning liquid nozzle for supplying cleaning liquid onto a surface of said substrate, wherein the rotating roller type cleaning members are pressed against respective surfaces of the turning substrate to clean the surface thereof while supplying the cleaning liquid from the cleaning liquid nozzle.

As semiconductor devices have become highly integrated and wiring patterns have become increasingly miniaturized, an urgent demand for reducing the number of residual dust particles on the semiconductor wafers has arisen, which requires high standards of purity. A semiconductor substrate having been polished in a substrate polishing apparatus (e.g. CMP) is set in a substrate cleaning apparatus having the above-described configuration by a conveying mechanism with the surface on which a pattern is to be formed facing upward and then cleaned.

At this time, abrasive grains, shavings or abrasive liquids produced in the polishing process adhere to the pattern forming surface, namely, the polished surface of the semiconductor wafer, and there are most likely tens of thousands of particles having diameters greater than 0.2 μm present thereon. In contrast, there are probably no more than a few thousand particles present on the surface opposite the surface on which the pattern is to be formed, namely, the bottom surface of the substrate, because it is held in a carrier of the polishing apparatus.

Regarding the number of particles on a semiconductor wafer, a higher level of cleanliness is required for the surface on which a pattern is to be formed (hereafter referred to as a pattern forming surface) in comparison with the bottom surface. However, it has been observed that the number of residual particles on the semiconductor wafer after being polished by the substrate polishing apparatus is distinctly higher on the surface on which the pattern is to be formed, and if the substrate is cleaned in the above-described cleaning apparatus in this manner, contamination would occur much faster in the roller type cleaning member that has been used to clean the pattern forming surface of the semiconductor wafer in comparison with a roller type cleaning member that has been used to clean the bottom surface. One drawback of this is that the roller type cleaning members need to be replaced earlier.

### SUMMARY OF THE INVENTION

The present invention has been made in light of the above-mentioned situation, and a primary object thereof is to provide a substrate cleaning apparatus, a substrate cleaning method and a substrate processing apparatus which can slow down the advance of contamination in a roller type cleaning member used for cleaning a pattern forming surface and thus can delay the need for replacing the cleaning member.

In order to solve the above-described problem, the present invention provides a substrate cleaning apparatus comprising: a substrate turning mechanism for turning a substrate on an approximately horizontal plane; a pair of roller type cleaning members rotating around respective rotary shafts disposed approximately parallel to respective surfaces of the substrate turning on the substrate turning mechanism; and a cleaning liquid nozzle for supplying cleaning liquid onto a surface of the substrate, wherein the substrate is cleaned by pressing the rotating roller type cleaning members against respective surfaces of the turning substrate while supplying the surface of the substrate with the cleaning liquid from said cleaning liquid nozzle.

The substrate cleaning apparatus is characterized in that said cleaning liquid nozzle is one which can impart ultrasonic energy to the cleaning liquid and/or generate cavitation in the cleaning liquid to be supplied, and the substrate is cleaned while supplying the cleaning liquid which has been given the ultrasonic energy and/or had the cavitation generated therein from said cleaning liquid nozzle onto the surface of the substrate.

Since the substrate is cleaned while supplying the cleaning liquid added with the ultrasonic energy and/or the cavitation generated therein onto the surface of the substrate from the cleaning liquid nozzle, the effect(s) from this ultrasonic energy and/or cavitation may help remove a majority of particles on the surface of the substrate before coming into contact with the roller type cleaning member, thereby slowing down the occurrence of contamination in the roller type cleaning member.

The present invention further provides a substrate cleaning method by means of the substrate cleaning apparatus described above. The method is characterized in that after being cleaned by supplying the cleaning liquid which has been given the ultrasonic energy and/or had the cavitation generated therein from the cleaning liquid nozzle onto the surface of the substrate, the substrate is further cleaned by pressing the rotating roller type cleaning members against both surfaces of the substrate.

Since the surface of the substrate is supplied with the cleaning liquid which is given ultrasonic energy and/or had cavitation generated therein from the cleaning liquid nozzle and cleaned up before the roller type cleaning members are pressed against both surfaces of the substrate as described above, almost all of the particles on the surface of the substrate are removed and the roller type cleaning member is used to remove just a small number of remaining particles, which helps slow down the occurrence of contamination in the roller type cleaning member.

The present invention further provides a substrate cleaning method using the substrate cleaning apparatus described above. The method is characterized in that upon pressing the rotating roller type cleaning members against both surfaces of the substrate to clean them, the cleaning liquid that is given the ultrasonic energy and/or had the cavitation generated therein is supplied from the cleaning liquid nozzle onto the surface of the substrate at an edge portion thereof to clean said edge portion.

It is difficult for the roller type cleaning members for cleaning both surfaces of the substrate to completely remove those particles on the edge portion of the substrate. In this regard, in the method according to the present invention, the edge portion of the substrate is supplied with the cleaning liquid added with the ultrasonic energy and/or had the cavitation generated therein from the cleaning liquid nozzle, so that the contaminants on the portion of interest may be selectively removed.

The present invention further provides a substrate processing apparatus comprising a substrate polishing apparatus for polishing a substrate and the substrate cleaning apparatus described above. The substrate processing apparatus is characterized in that the substrate having been polished in the substrate polishing apparatus is held by the substrate turning mechanism of the substrate cleaning apparatus, and then the rotating roller type cleaning members are pressed against both surfaces of the turning substrate while supplying the cleaning liquid that has been given the ultrasonic energy and/or had the cavitation generated therein from the cleaning liquid nozzle onto the surface of the turning substrate to clean the surfaces of the substrate.

As described above, since the surface of the substrate, which has been polished in the substrate polishing apparatus, is cleaned while supplying the cleaning liquid that has been added with the ultrasonic energy and/or the cavitation generated therein from the cleaning liquid nozzle onto the surface of the substrate, the number of residual particles on the surface of the substrate may be significantly reduced, thereby possibly reducing the rate of contamination in the roller type cleaning member.

The present invention further provides a substrate cleaning method using the substrate processing apparatus described above. The said method is characterized in that the substrate having been polished in the substrate polishing apparatus is cleaned in the substrate cleaning apparatus: firstly, by supplying the cleaning liquid that has been given ultrasonic energy and/or had cavitation generated therein from the cleaning liquid nozzle onto the polished surface of the substrate; and secondly, either by pressing the rotating roller type cleaning members against both surfaces of the substrate to clean the substrate, or by pressing the rotating roller type cleaning members against both surfaces of the substrate and additionally supplying the cleaning liquid that has been given ultrasonic energy and/or had cavitation generated therein from the cleaning liquid nozzle onto the edge portion of the polished surface of the substrate.

Since the substrate is cleaned in the above described manner, contamination occurs more slowly in the roller type cleaning member, similarly to those in the above mentioned inventions.

### BRIEF DESCRIPTION OF THE DRAWINGS

FIG. 1 is a perspective view illustrating a general configuration of a substrate cleaning apparatus according to the present invention.

FIG. 2 is a diagram for explaining processes included in a substrate cleaning method according to the present invention.

FIG. 3 shows an exemplary configuration of a cleaning liquid nozzle for imparting ultrasonic energy to cleaning liquid.

FIG. 4 shows an exemplary configuration of a cleaning liquid nozzle for generating cavitation in cleaning liquid.

FIG. 5 is a schematic plan view illustrating an exemplary substrate processing apparatus according to the present invention.

FIG. 6 is a perspective view of main components, illustrating in detail an interior of a cleaning section of the substrate processing apparatus shown in FIG. 5.

FIG. 7 shows a configuration of a secondary substrate cleaning apparatus of the substrate processing apparatus shown in FIG. 5.

FIG. 8 shows a configuration of a spin-dryer unit with a cleaning function of the substrate processing apparatus shown in FIG. 5.

### DETAILED DESCRIPTION OF THE INVENTION

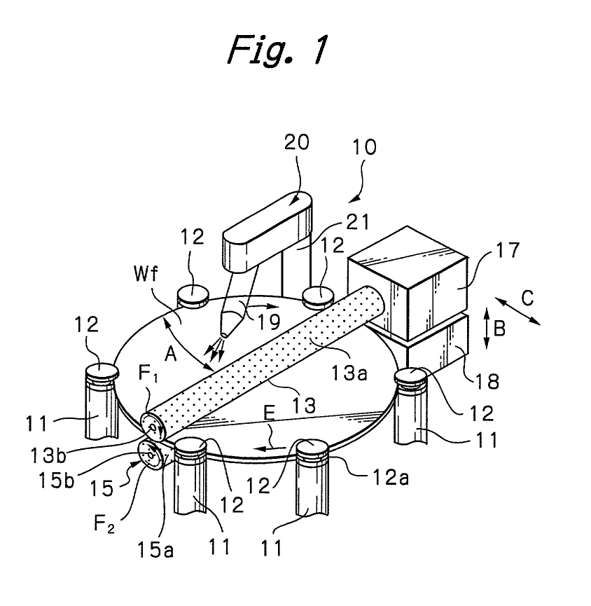

Hereinafter, preferred embodiments of the present invention will be described in detail with reference to the accompanying drawings. FIG. 1 is a perspective view illustrating a general configuration of a substrate cleaning apparatus according to the present invention. This substrate cleaning apparatus 10 comprises: a plurality of spindles 11 (these are supporting members equipped with a turning mechanism; six spindles are shown in the drawing) for rotatably supporting the outer periphery of a disc-like substrate Wf to be cleaned, such as a semiconductor wafer; a pair of roller type cleaning members 13 and 15 formed into roll shapes respectively with one arranged on, and the other arranged beneath, the substrate Wf to be cleaned; a pair of driving mechanisms 17 and 18 for bringing rotary shafts 13b and 15b disposed parallel with the planes of the substrate Wf to be cleaned, to move close to or away from said substrate Wf to be cleaned and to rotate in the directions indicated by arrows F1 and F2 respectively; and a cleaning liquid nozzle 19 for supplying cleaning liquid onto a surface of the substrate Wf to be cleaned.

The cleaning liquid nozzle 19 utilizes either an ultrasonic nozzle which imparts ultrasonic energy to the cleaning liquid to be injected, or a cavitation nozzle which generates cavitation in the cleaning liquid to be injected, or an ultrasonic cavitation nozzle which generates the cavitation in the cleaning liquid while imparting the ultrasonic energy into it, each of which will be explained in detail later.

The cleaning liquid nozzle 19 is mounted to a cleaning arm 20 to supply the cleaning liquid onto the substrate Wf to be cleaned while being swung by an arm drive shaft 21 in the direction indicated by an arrow A. Further, the cleaning liquid nozzle 19 is adapted to be at rest in a specified position above the substrate Wf to be cleaned or to be in a retracted position. In addition, the bottom face side (the reverse face side) of the under-cleaning substrate Wf is also provided with a cleaning liquid nozzle for supplying the cleaning liquid, though this is omitted from the illustration.

However, for the cleaning liquid supplied from the nozzle disposed in the bottom face side of the substrate, it is not required to impart ultrasonic energy thereto or to generate the cavitation therein differently from that supplied from the nozzle disposed above the substrate. It is also unnecessary to swing said cleaning liquid nozzle disposed in the bottom face side.

Each of the roller type cleaning members 13 and 15 comprises a cylindrical body 13a or 15a made of porous PVF sponge and a shaft 13b or 15b inserted into said cylindrical body, respectively. It has been experimentally found that a smaller average diameter of pores formed in the sponges, which make up those cylindrical bodies 13a and 15a, increases cleaning abilities of the roller type cleaning members 13 and 15 to remove dust (particles), and preferably said average diameter should be 110 μm or smaller. These cylindrical bodies 13a and 15a may be made of expanded urethane.

The driving mechanisms 17 and 18 are designed to be moved up and down respectively by a driving mechanism (not shown) so as to be spaced away from the substrate Wf to be cleaned as indicated by arrow B, and also to be shifted in the direction indicated by arrow C and thereby to be placed in their retracted positions.

To clean the substrate Wf, the substrate Wf is first placed in a position with its surface to be cleaned facing upward and its outer periphery accommodated in circumferential grooves 12a formed in head pieces 12 of the upper portions of the spindles 11 so as to be tightly held thereby; then, the substrate Wf is turned in the direction indicated by arrow E at an approximately regulated speed of rotation by rotating each of those head pieces 12 at the same high speed and the same direction of rotation.

Next, a pair of rotating roller type cleaning members 13 and 15 is brought into contact with the top and the bottom surfaces of said substrate Wf so that the substrate Wf may be sandwiched therebetween, and at the same time, the cleaning liquid added with the ultrasonic energy, the cleaning liquid having the cavitation generated therein, or the cleaning liquid having both the ultrasonic energy added thereto and the cavitation generated therein is injected from the cleaning liquid nozzle 19.

Further, in parallel with this, the bottom surface of the substrate Wf to be cleaned is also supplied with cleaning liquid from another cleaning liquid nozzle (not shown). By way of this operation, the particles adhered to the top and the bottom surfaces of the substrate Wf to be cleaned may be removed.

Since, as described above, there are some tens of thousands of particles with particle diameters of 0.2 μm or greater present on the polished surface of a substrate to be cleaned such as a semiconductor wafer or the like which has been polished by a substrate polishing apparatus (e.g. CMP), when said polished surface, as placed facing upward as described above, is supplied with such cleaning liquid that has been added with the ultrasonic energy, the generated cavitation, or both of the ultrasonic energy and the generated cavitation, from the cleaning liquid nozzle 19 so as to be cleaned thereby, almost all the residual particles on the polished surface of the substrate Wf to be cleaned may be removed by the effect of said ultrasonic energy or cavitation before the roller type cleaning member 13 coming into contact with the polished surface of the substrate, and thereby the contamination to be developed in the roller type cleaning member 13 could be slowed down.

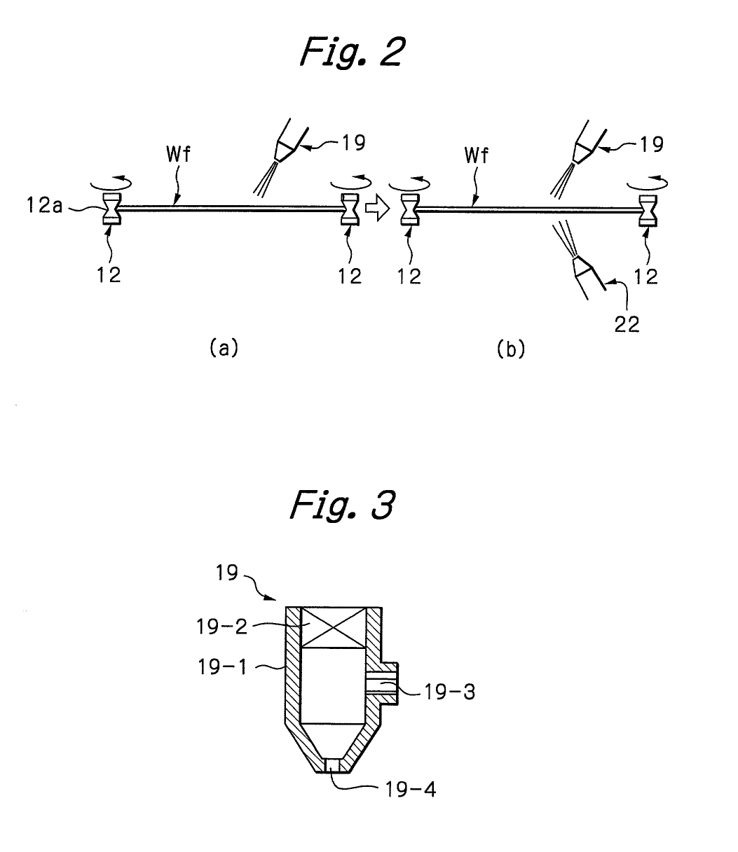

Alternately, the cleaning processes shown in FIG. 2 (a) and (b) may be used to clean the substrate Wf to be cleaned, since many more residual particles remain on the polished surface of the substrate Wf that has been polished by the substrate polishing apparatus compared with the residual particles remaining on the reverse side surface of the substrate Wf, as described above. That is, the substrate Wf to be cleaned is set in the head pieces 12 of the upper portions of the spindles 11 with the polished surface facing upward and rotated as shown in FIG. 2(a), and, firstly, the polished surface is supplied and cleaned with the cleaning liquid added with the ultrasonic energy and/or the generated cavitation.

After that, as shown in FIG. 2(b), the pair of rotating roller type cleaning members 13 and 15 is brought into contact with the top and the bottom surfaces of the substrate Wf to be cleaned, and the top and the bottom surfaces are cleaned while supplying the cleaning liquid from cleaning liquid nozzle 19 and cleaning liquid nozzle 22 thereto.

Since, as described above, the polished surface is cleaned by supplying the cleaning liquid added with the ultrasonic energy and/or the cavitation generated, from the cleaning liquid nozzle 19 before the top and the bottom surfaces of the substrate Wf to be cleaned are cleaned by the roller type cleaning members 13 and 15, and thereby almost all the particles having remained on the polished surface may be removed by the effect of ultrasonic energy and/or cavitation, and said roller type cleaning member 13 is used after those removed particles have been removed together with the cleaning liquid, to remove the still-remaining particles, accordingly the roller type cleaning member 13 may be contaminated much slowly and is allowed to operate longer.

It is to be noted that in the secondary cleaning stage of FIG. 2(b), the cleaning liquid injected from the cleaning liquid nozzle 19 and cleaning liquid nozzle 22 is not required to be given any ultrasonic energy or cavitation generated. Of course, it is apparent that the ultrasonic energy may be given to or the cavitation may be generated in the cleaning liquid. It is to be noted also that although ultrapure water has been used as the cleaning liquid in this embodiment, other liquids such as chemicals or the like may be variously used, if required, depending on the kind and/or the degree of contamination of the substrate to be cleaned.

Further, in the above described substrate cleaning apparatus in which the outer periphery of the substrate Wf to be cleaned is accommodated in the circumferential grooves 12a formed in the head pieces 12 of the upper portions of the spindles 11 so as to be tightly held therein, and each of the head pieces 12 is rotated at high speed thus to turn the substrate Wf to be cleaned, the outer periphery or the edge portion of the substrate Wf to be cleaned is in constant contact with the circumferential grooves 12a, and thereby many particles may adhere to said edge portion.

In this regard, upon bringing the roller type cleaning members 13 and 15 into contact with the top and the bottom surfaces of the substrate Wf to be cleaned for cleaning, preferably the cleaning liquid nozzle 19 should rest above the edge portion of the substrate Wf to be cleaned, so that the cleaning liquid that has been given the ultrasonic energy and/or had the cavitation generated therein may be delivered from the cleaning liquid nozzle 19 onto the edge portion of the top surface for selectively cleaning said portion. Herein, the edge portion collectively refers to an end portion of the substrate and a side face portion adjacent to said end portion.

FIG. 3 shows an exemplary configuration of a cleaning liquid nozzle (an ultrasonic cleaning liquid nozzle) 19 for imparting ultrasonic energy to the cleaning liquid. The cleaning liquid nozzle 19 comprises a nozzle body 19-1 and an ultrasonic vibrator 19-2 housed in said nozzle body 19-1. Said ultrasonic vibrator 19-2 is able to impart cleaning liquid vibrations in a range of 500 Hz to 1.5 MHz. Introducing high pressure cleaning liquid (e.g., ultrapure water) into the nozzle body 19-1 through a cleaning liquid inlet port 19-3 with said ultrasonic vibrator 19-2 being in an active state allows the cleaning liquid powered by the ultrasonic energy to be supplied from the injection outlet port 19-4 onto the surface of the substrate Wf to be cleaned.

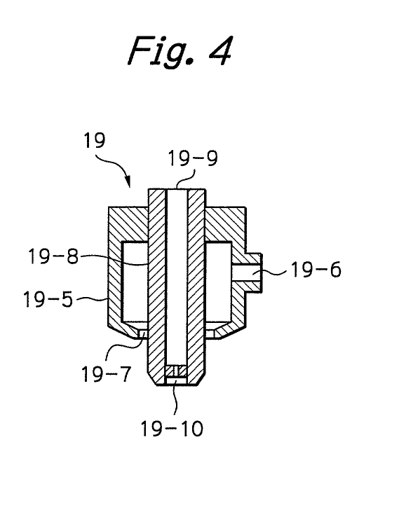

FIG. 4 shows an exemplary configuration of a cleaning liquid nozzle (a cavitation cleaning liquid nozzle) 19 for generating cavitation in the cleaning liquid. The cleaning nozzle 19 comprises a low-pressure nozzle 19-5 and a high-pressure nozzle 19-8.

When the cleaning liquid (e.g., ultrapure water) at a low pressure in the range of 1 to 2 kg/cm² is introduced through the cleaning liquid inlet port 19-6 of the low-pressure nozzle 19-5 and at the same time the cleaning liquid (e.g., ultrapure water) at a high pressure in a range of 30 to 150 kg/cm² is introduced through the cleaning liquid inlet port 19-9 of the high-pressure nozzle 19-8, the high-speed cleaning liquid jet flow injected from a cleaning liquid injection outlet port 19-10 of the high pressure nozzle 19-8 passes through the low-speed cleaning liquid jet flow injected from the cleaning liquid injection outlet port 19-7 of the low-pressure nozzle 19-5, so that the cavitation is generated at the boundary between both cleaning liquid jet flows.

Then, positioning the surface of the substrate to be cleaned in a specific location where the cavitation would be broken may impart the breaking energy of the cavitation to the particles and thereby said particles will be released from the surface of the substrate to be cleaned.

It is to be appreciated that although in the above embodiments the exemplary configurations have been illustrated for the application to the case where the ultrasonic energy is given to the cleaning liquid or the cavitation is generated in the cleaning liquid, such a configuration is obviously applicable that the ultrasonic energy is given to the cleaning liquid as well as the cavitation being generated therein simultaneously.

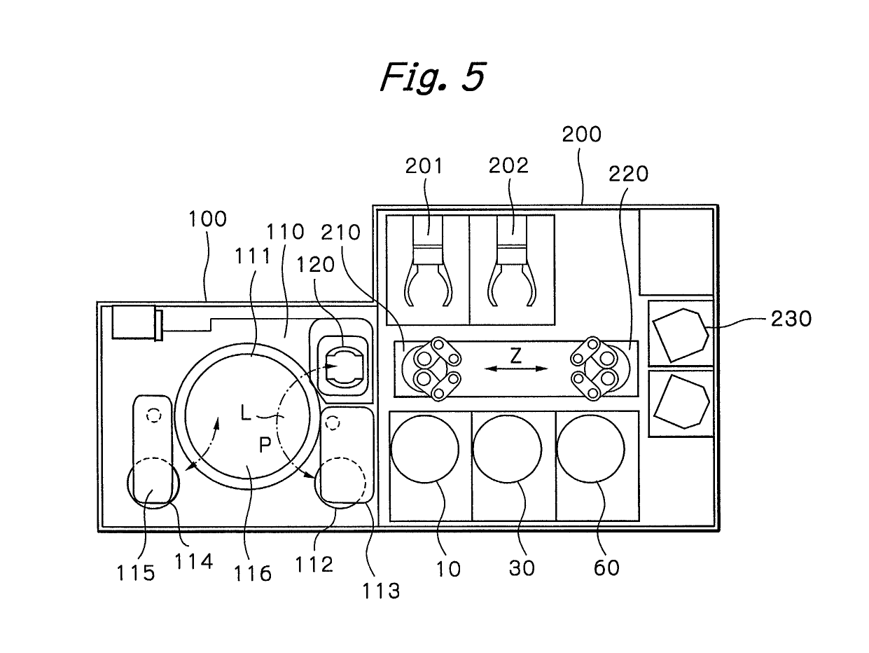

FIG. 5 is a schematic plan view illustrating an exemplary substrate processing apparatus equipped with a substrate cleaning apparatus of the above configuration. It is to be noted that herein a substrate to be cleaned and a substrate to be polished are collectively referred to as a substrate to be processed “Wf”. The present substrate processing apparatus comprises a polishing section 100 and a cleaning section 200. The polishing section 100 is provided with a polishing apparatus 110 and a work transferring device 120 for receiving and passing a substrate Wf to be processed. The polishing apparatus 110 is configured such that a turntable 111 is disposed in its center, a polishing unit 113 with a top ring mounted thereto is disposed in one side with respect to said turn table 111, and a dressing unit 115 with a dressing tool 114 mounted thereto is disposed in the other side with respect to said turn table On the other hand, in the cleaning section 200, two conveying robots 210 and 220 capable of moving in the direction indicated by an arrow Z are disposed in its center; a primary substrate cleaning apparatus 10, a secondary substrate cleaning apparatus 30 and a spin-dryer unit 60 having a cleaning function are arranged in parallel side by side in one side with respect to said conveying robots 210 and 220; and two work turning-over machines 201 and 202 for turning over the substrate Wf to be processed are disposed on the other side with respect to robots 201 and 202.

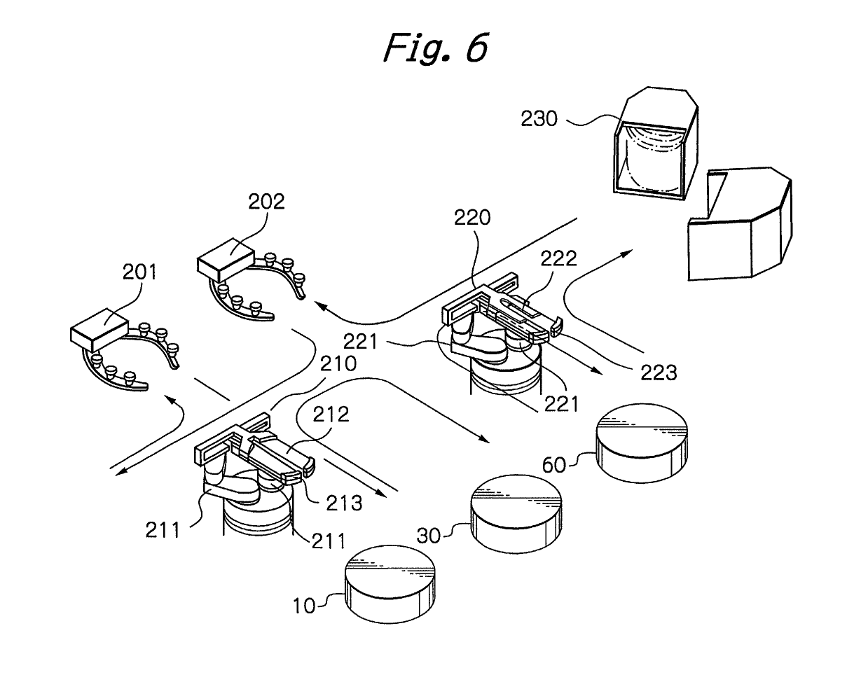

FIG. 6 is a perspective view of main components, illustrating in detail the interior of the cleaning section 200. As shown, each of the conveying robots 210 and 220 includes two sets of arm mechanisms 211 and 221 mounted to top surfaces thereof respectively. Respective tips of arm mechanisms 211 and 221 are provided with hands 212, 213, 222, and 223 respectively for holding the substrate Wf to be processed. It is to be noted that the hands 212 and 213 should be disposed one on the other, and hands 222 and 223 similarly disposed.

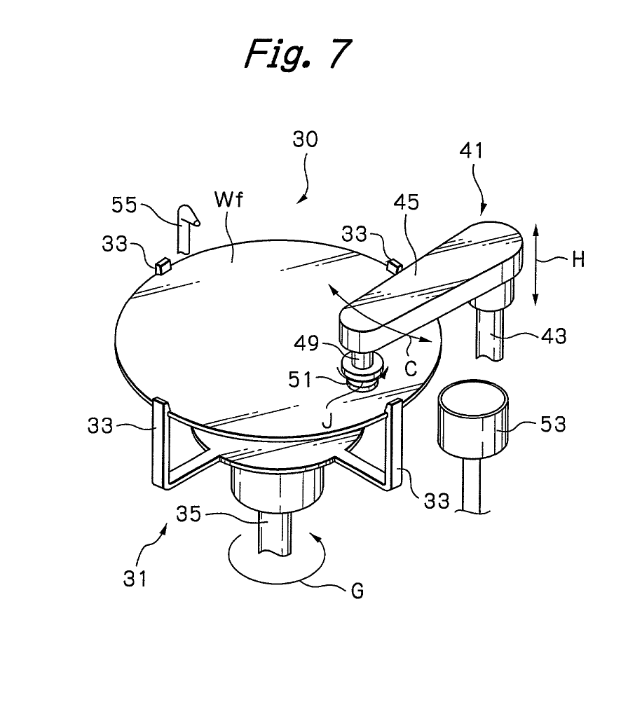

The primary substrate cleaning apparatus 10 is a substrate cleaning apparatus with a configuration shown in FIG. 1. The secondary cleaning apparatus 30 is a pencil-type substrate cleaning apparatus comprising a rotary chuck mechanism 31 and a pencil-type brush cleaning mechanism 41, as shown in FIG. 7. The rotary chuck mechanism 31 has a plurality of chucking pawls 33 arranged in an upper portion thereof for chucking the outer periphery of the disc-like substrate Wf to be processed, and is driven by a revolving drive shaft 35 to rotate in the direction indicated by the arrow G. The chucking pawls 33 of the rotary chuck mechanism 31 are also equipped with opening and closing mechanisms, though not shown in FIG. 7, so that the substrate Wf to be processed may be conveyed in and out by the hands of the robots.

The pencil type brush cleaning mechanism 41, as shown in FIG. 7, includes a swing arm 45, one end of which is supported by a shaft 43 and the other end of which is provided with a rotary drive shaft 49 protruding vertically downward toward the cleaning surface of the substrate to be processed Wf, said rotary drive shaft 49 having a pencil-type cleaning member 51 made of porous PVF sponge attached to the lower end thereof. This pencil-type cleaning member 51 may be made of expanded polyurethane.

The pencil-type cleaning member 51 is formed into an approximately cylindrical shape with a bottom face, where the face to be brought into contact with the substrate Wf to be processed is flat. The pencil-type cleaning member 51 can be, for example, about 5 mm high and have an outer diameter of about 20 mm. The average pore diameter for the fine pores formed in the sponge is about 110 μm. Since a smaller pore diameter may improve the effect of the sponge, the pore diameter should preferably be smaller than 80 μm.

The shaft 43 is allowed to move up and down as indicated by the arrow H and also rotates to cause a swing motion of the swing arm 45 in the direction indicated by an arrow I; further, the rotation of the rotary drive shaft 49 causes the pencil type cleaning member 51 to rotate in the direction indicated by the arrow J. The secondary substrate cleaning apparatus 30 further comprises a cleaning liquid nozzle 55 for supplying the cleaning liquid. In addition, the secondary substrate cleaning apparatus 30 further comprises a cup-like brush housing 53 for accommodating and cleaning the pencil-type cleaning member 51 during the down time of the pencil-type brush cleaning mechanism 41.

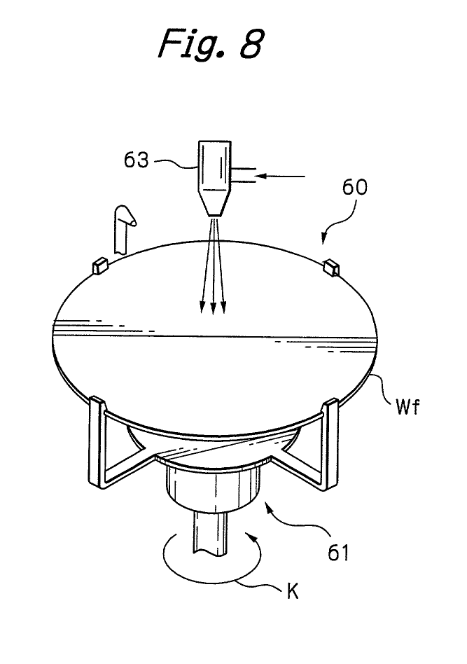

FIG. 8 shows the main components of the spin-dryer unit 60 with a cleaning function. As shown in FIG. 8, the spin-dryer unit 60 with a cleaning function comprises a rotary chuck mechanism 61 and a cleaning liquid nozzle 63. Said cleaning liquid nozzle 63 is attached to a tip of a cleaning arm capable of swinging, which is similar to the cleaning arm 20 shown in FIG. 1, and injects the cleaning liquid onto the surface of slowly rotating substrate Wf to be processed while moving around on the substrate Wf to be processed, similarly to the cleaning arm 20.

After the cleaning liquid has been injected, the rotary chuck mechanism 61 rotates at high speed in the direction indicated by the arrow K to produce a fast rotation of the substrate Wf to be processed, thereby accomplishing spin-drying. As cleaning liquid nozzle 63, a nozzle similar to the cleaning liquid nozzle 19 is employed for injecting the cleaning liquid which has been given ultrasonic energy and/or has had cavitation generated therein.

Now, an operation of the substrate processing apparatus shown in FIG. 5 will be described. A substrate Wf to be processed is taken out by hand 222 of the conveying robot 220 (see FIG. 6) from a cassette 230 containing a plurality of substrates Wf to be processed before being polished; it is then transferred to the work turning-over machine 202, which turns over the substrate Wf to be processed so that the surface to be polished (e.g. a circuit pattern forming surface) faces downward. Further, the substrate Wf to be processed is transferred from the work turning-over machine 202 to the hand 212 of the conveying robot 210 and forwarded to the work transferring device 120 of the polishing section 100.

The substrate Wf to be processed placed on the work transferring device 120 is held on the lower face of the top ring 112 of the polishing unit 113 capable of swinging as indicated by an arrow L, and is transferred onto the turn table 111 where the substrate Wf is polished on the rotating polishing plane 116. At that time, an abrasive liquid is supplied onto the polishing plane 116 from an abrasive liquid supply tube (not shown). After having been polished, the substrate Wf to be processed is returned to the work transferring device 120, and transferred to the work turning-over machine 201 by the hand 213 of the conveying robot 210 (see FIG. 6), where the substrate is turned over while being rinsed with a rinsing liquid, and then transferred to the primary substrate cleaning apparatus 10 by the hand 213.

In the primary substrate cleaning apparatus 10, as described above, each of the pair of rotating roller type cleaning members 13 and 15 is respectively brought into contact with the top or the bottom surfaces of the substrate Wf to be processed, and the cleaning liquid that has been given ultrasonic energy and/or had cavitation generated therein is injected from the cleaning liquid nozzle 19, so that the particles adhered to the top and the bottom surfaces of the substrate Wf to be processed may be removed with the cleaning liquid.

Further, since before this cleaning by the roller type cleaning members 13 and 15 the majority of residual particles on the polishing surface can be removed by injecting through the cleaning liquid nozzle 19 the cleaning liquid added with ultrasonic energy and/or cavitation generated therein onto the top surface of the substrate Wf to be processed, the occurrence of contamination in the roller type cleaning members 13 and 15 may be slowed down.

Still further, upon cleaning the substrate Wf to be processed with the roller type cleaning members 13 and 15, the cleaning liquid nozzle 19 is located above the edge portion of the substrate Wf to be processed and the cleaning liquid added with the ultrasonic energy and/or the cavitation generated therein is supplied from the cleaning liquid nozzle 19 onto said edge portion, whereby said edge portion is selectively cleaned.

This can remove a majority of particles that have adhered to the edge portion due to the outer periphery or the edge portion of the substrate Wf to be processed being in constant contact with the circumferential groove 12a of the head pieces 12. After having been cleaned by the primary substrate cleaning apparatus 10 in the manner described above, the substrate Wf to be processed is then transferred by the hand 212 of the conveying robot 210 from the primary substrate cleaning apparatus 10 to the secondary substrate cleaning apparatus 30.

In the secondary cleaning apparatus 30, the outer periphery of the substrate Wf to be processed is chucked by the chuck 33, and in this state, the chuck mechanism 31 is rotationally driven as a whole by the drive shaft 35 to be spun at a high speed, so that the substrate Wf to be processed is turned at a predetermined revolving speed in the range of from 500 to 1500 rpm.

The revolving speed of the substrate Wf to be processed driven by the rotary chuck 31 during processing may be selectively chosen within the range of the allowable revolving speed by means of a revolving controller of a drive motor (not shown) connected to the rotary drive shaft 35. The top surface of the substrate Wf to be processed is cleaned by bringing the spinning pencil-type cleaning member 51 into contact with the top surface of the turning substrate Wf to be processed, and supplying the cleaning liquid from the cleaning liquid nozzle 55 onto it while swinging the swing arm 45.

After having been cleaned in the secondary cleaning apparatus 30 as described above, the substrate Wf to be processed is conveyed by the hand 223 of the conveying robot 220 to the spin-dryer with cleaning function 60. In the spin-dryer 60, firstly the cleaning liquid added with ultrasonic energy and/or cavitation generated therein is injected from the cleaning liquid nozzle 63 onto the top surface of the substrate Wf to be processed which is turning as held by the rotary chuck mechanism 61 to clean the substrate Wf, and thereafter the substrate Wf to be processed is spun at a high speed so as to be dried.

After having been dried, the substrate Wf to be processed is returned to the original cassette 230 by the hand 222 of the conveying robot 220. It is to be noted that since this function of spin-drying may also be accomplished by revolving at a high speed the whole rotary chuck mechanism 31 of the secondary substrate cleaning apparatus 30, the spin-drying may be performed in the secondary substrate cleaning apparatus 30, and in this case the spin-dryer with cleaning function 60 may be omitted.

### EFFECT OF THE INVENTION

As has been described above, according to the invention defined in the respective appended claims, the advantages of the present invention are as described below. According to the present invention, since the surface of the substrate is cleaned while supplying the cleaning liquid added with ultrasonic energy and/or cavitation generated therein onto the surface of the substrate from the cleaning liquid nozzle, and a majority of particles on the surface of the substrate may be removed by the effect of this ultrasonic energy and/or cavitation, the occurrence of contamination in the roller type cleaning member may be slowed down and the roller type cleaning member can be used for longer periods; namely, a longer operating time thereof can be accomplished.

Further, according to the present invention, since a surface of the substrate has been cleaned by supplying from the cleaning liquid nozzle the cleaning liquid that had been given ultrasonic energy and/or had cavitation generated therein before the roller type cleaning members were pressed against both surfaces of the substrate, that is, almost all of the particles on the surface of the substrate should have been removed before the operation of the roller type cleaning members and the roller type cleaning member is used to remove only a small number of remaining particles, the contamination occurring in the roller type cleaning member may be slowed down, and the roller type cleaning member can be used for a longer time; namely, a longer operating time thereof can be accomplished.

Still further, according to the present invention, by supplying the surface on the edge portion of the substrate with the cleaning liquid added with ultrasonic energy and/or cavitation generated therein from the cleaning liquid nozzle, contaminants on the edge portion of the substrate, where few particles have been removed by the roller type cleaning members working to clean both surfaces of the substrate, may be selectively removed, whereby the contamination occurring in the roller type cleaning member may be slowed down, and the roller type cleaning member can be used for longer periods; namely a longer operating time thereof can be accomplished.

Still further, according to the present invention, since the polished surface of the substrate, which has been polished by the substrate polishing apparatus, is cleaned while supplying from the cleaning liquid nozzle the cleaning liquid added with ultrasonic energy and/or cavitation generated therein, the processing may be performed under the condition where the residual particles on the polished surface of the substrate have been significantly reduced, and as a result, the occurrence of contamination to be developed in the roller type cleaning member of the substrate cleaning apparatus may be slowed down and the roller type cleaning member can be used for longer periods; namely, a longer operating time thereof can be accomplished.

Still further, according to the present invention, since a substrate is cleaned firstly by supplying the cleaning liquid that has been given ultrasonic energy and/or had cavitation generated, from the cleaning liquid nozzle onto the polished surface of the substrate, and secondly either by pressing the rotating roller type cleaning members against both surfaces of the substrate to clean the substrate, or by pressing the rotating roller type cleaning members against both surfaces of the substrate while additionally supplying the cleaning liquid that has been given ultrasonic energy and/or had cavitation generated from the cleaning liquid nozzle onto the edge portion of the polished surface of the substrate, the occurrence of contamination in the roller type cleaning member may be slowed down, and the roller type cleaning member can be used for longer periods; namely, a longer operating time thereof can be accomplished.

What is claimed is:

1. A substrate cleaning apparatus comprising: a substrate turning mechanism for turning a substrate on an approximately horizontal plane; a pair of roller type cleaning members rotating around rotary shafts disposed approximately parallel to respective surfaces of the substrate turning on said substrate turning mechanism; and a cleaning liquid nozzle for supplying cleaning liquid onto a surface of the substrate, wherein said substrate is cleaned by pressing said rotating roller type cleaning members against respective surfaces of said turning substrate while supplying the cleaning liquid from said cleaning liquid nozzle,
wherein said cleaning liquid nozzle is a cleaning liquid nozzle which can impart ultrasonic energy to the cleaning liquid and/or generate cavitation in the cleaning liquid to be supplied, and said substrate is cleaned while supplying the cleaning liquid which has been given the ultrasonic energy and/or had the cavitation generated therein from said cleaning liquid nozzle onto the surface of said substrate.

2. A substrate cleaning method using the substrate cleaning apparatus defined in claim 1, wherein after the substrate has been cleaned by supplying the cleaning liquid which has been given the ultrasonic energy and/or had the cavitation generated therein from said cleaning liquid nozzle onto the surface of said substrate, said substrate is further cleaned by pressing said rotating roller type cleaning members against both surfaces of said substrate.

3. A substrate cleaning method using the substrate cleaning apparatus defined in claim 1, in which when the substrate is cleaned by pressing said rotating roller type cleaning members against both surfaces of said substrate, the cleaning liquid which has been given the ultrasonic energy and/or had the cavitation generated therein is supplied from said cleaning liquid nozzle onto the surface of said substrate at an edge portion thereof to clean said edge portion.

4. A substrate processing apparatus comprising a substrate polishing apparatus for polishing a substrate and the substrate cleaning apparatus defined in claim 1,
wherein said substrate, having been polished in said substrate polishing apparatus, is held by said substrate turning mechanism of said substrate cleaning apparatus and then said rotating roller type cleaning members are pressed against both surfaces of said substrate while supplying the cleaning liquid which has been given the ultrasonic energy and/or had the cavitation generated therein from said cleaning liquid nozzle onto the surface of said turning substrate to clean the surfaces of said substrate.

5. A substrate cleaning method in a substrate processing apparatus defined in claim 4, wherein said substrate, having been polished in said substrate polishing apparatus, is cleaned in said substrate cleaning apparatus, firstly by supplying the cleaning liquid which has been given the ultrasonic energy and/or had the cavitation generated therein from said cleaning liquid nozzle onto the polished surface of said substrate, and secondly, either by pressing said rotating roller type cleaning members against both surfaces of said substrate to clean said substrate or by pressing said rotating roller type cleaning members against both surfaces of said substrate and additionally supplying the cleaning liquid which has been given the ultrasonic energy and/or had the cavitation generated therein from said cleaning liquid nozzle onto an edge portion of the polished surface of said substrate.

6. A substrate cleaning apparatus comprising: a substrate turning mechanism for turning a substrate;
a pair of roller type cleaning members rotating around rotary shafts disposed approximately parallel to respective surfaces of the substrate; and
a cleaning liquid nozzle for supplying cleaning liquid onto at least one of said surfaces of the substrate, wherein said substrate is cleaned by pressing said rotating roller type cleaning members against respective said surfaces while supplying the cleaning liquid from said nozzle, wherein said nozzle which can impart ultrasonic energy to the cleaning liquid and/or generate cavitation in the cleaning liquid to be supplied.

7. A substrate cleaninig apparatus as set forth in claim 6, wherein the cleaning nozzle can be adapted to be at rest in specified position above the substrate to be cleaned or to be in a retracted position.

8. A substrate cleaning apparatus as set forth in claim 6, further comprising a pair of cleaning member driving mechanism which can be moved up and down respectively said cleaning members.

9. A substrate cleaning apparatus as set forth in claim 6, wherein the cleaning nozzle can be adapted to be onto the top surface of the edge portion of the substrate for selectively cleaninig said portion.

10. A substrate cleaning apparatus as set forth in claim 6, wherein said cleaning liquid is given ultrasonic energy as well as cavitation simultaneously by said nozzle.

11. A substrate cleaning apparatus as set forth in claim 6, wherein said turning mechanism can accomplish drying for said substrate.
